(19) United States
(12) Patent Application Publication
(10) Pub. No.: US 2010/0319420 A1
(43) Pub. Date: Dec. 23, 2010

(54) WAFER CYLINDER HAVING BLOCKABLE WAFER TUMBLERS

(75) Inventors: Hoi Jarm Ng, Hong Kong (CN); Wai Leung Ng, Hong Kong (CN); Thomas Becker, Hunfelden-Heringen (DE)

Correspondence Address: GIFFORD, KRASS, SPRINKLE,ANDERSON & CITKOWSKI, P.C, PO BOX 7021, TROY, MI, 48007-7021, US

(73) Assignee: ABUS August Bremicker Soehne KG, Wetter-Volmarstein (DE)

(21) Appl. No.: 12/817,667

(22) Filed: Jun. 17, 2010

(30) Foreign Application Priority Data
Jun. 23, 2009 (DE) DE 102009030032.5

(51) Int. Cl. E05B 29/04

(52) U.S. Cl. 70/367

(57) ABSTRACT

The invention relates to a cylinder lock of the type of a disk tumbler cylinder having a cylinder housing and a cylinder core rotatable therein, with a plurality of blockable disk tumblers being provided in the cylinder core which have at least one respective engagement section. The disk tumblers are movable between an unlatched position and a latched position and are biased along a respective direction of bias into the latched position. In the latched position, the respective engagement section engages into an associated cut-out in the cylinder housing to block the cylinder core against a rotary movement relative to the cylinder housing. The cylinder core is rotatable in a rotary opening direction relative to the cylinder housing when the disk tumblers are in the unlatched position. At least one of the disk tumblers has a toothed zone which can be brought into engagement with a counter-toothed zone of the cylinder lock such that the disk tumbler is blocked against a movement opposite to the respective direction of bias when the disk tumbler is in the latched position and a torque is exerted onto the cylinder core in the rotary opening direction.

### CROSS-REFERENCE TO RELATED APPLICATION

This application claims priority of German Patent Application 10 2009 030 032.5 filed Jun. 23, 2009.

### FIELD OF THE INVENTION

The invention relates to a cylinder lock of the type of a disk tumbler cylinder (also denoted as a wafer cylinder) having a cylinder housing and a cylinder core rotatable therein, with a plurality of disk tumblers (also denoted as wafer tumblers) being provided in the cylinder core which have at least one respective engagement section. The disk tumblers are movable between an unlatched position and a latched position and are biased along a respective bias direction into the latched position. In the latched position, the respective engagement section engages into an associated cut-out in the cylinder housing to block the cylinder core against a rotary movement relative to the cylinder housing. The cylinder core is rotatable in a rotary opening direction relative to the cylinder housing when the disk tumblers are in the unlatched position.

### BACKGROUND OF THE INVENTION

A problem with such a cylinder lock is the so-called locking picking. This is understood as the attempt to open a cylinder lock without force without a matching key. For this purpose, special opening tools are used with which the disk tumblers are moved out of their respective latched position against the bias up to the ring gap between the cylinder housing and the cylinder core. If in so doing a suitable torque is simultaneously exerted onto the cylinder core in the rotary opening direction, for example by means of a so-called tensioning lever, it can thus be achieved in some cases while utilizing the usually present rotary play that the disk tumblers catch at the edge of the associated cut-out of the cylinder housing so that the cylinder core can be rotated without the desired blocking effect. In this respect, one speaks of a “setting” of the disk tumblers which is carried out sequentially for the individual disk tumblers.

A cylinder lock of the kind named above is known from DE 10 2007 056 739 A1. With this cylinder lock, an increased security against locking picking is achieved in that at least two of the disk tumblers have different rotary play between the engagement section of the respective disk tumbler and the lateral boundary of the associated cut-out in the cylinder housing located in the rotary opening direction. Whereas such a cylinder lock has proven itself in practice, there is a need to increase the security against locking picking even further.

It is an object of the invention to provide a cylinder lock of the type of a disk tumbler cylinder which has improved security against manipulation, in particular with respect to the explained locking picking.

This object is satisfied by a cylinder lock having the features of claim 1, and in particular in that at least one of the disk tumblers has a toothed zone which can be brought into engagement with a counter-toothed zone of the cylinder lock such that the disk tumbler is blocked against a movement of the respective direction of bias when the disk tumbler is located in the latched position and a torque is exerted onto the cylinder core in the rotary opening position.

With the cylinder lock in accordance with the invention, a respective toothed zone of one or more of the disk tumblers cooperates with an associated counter-toothed zone of the cylinder lock through a mutual toothed engagement such that the respective disk tumbler is blocked in the latched position when a torque is exerted onto the cylinder core in the rotary opening direction. In this respect, a shape matching is caused between the named toothed zone and the associated counter-toothed zone. The “setting” of the respective disk tumbler explained above is thus prevented, namely in that it is not permitted at all that the respective disk tumbler is moved out of the latched position into the unlatched position in an unauthorized manner. In this respect, the circumstance is utilized that, on a typical manipulation attempt, a torque is simultaneously exerted onto the cylinder core in the rotary opening direction, which is not the case with an intended actuation of the cylinder lock by means of the associated key. In other words, the named toothed zone of the respective disk tumbler enters into toothed engagement with the associated counter-toothed zone as soon as, starting from the latched position of the disk tumbler, the cylinder core is rotated in the rotary opening direction (which is possible to a specific degree due to the rotary play which is present). The respective disk tumbler can thus not be brought into the unlatched position at all from the start within the framework of a typical picking attempt so that there is also no risk that the disk tumbler (and in particular all disk tumblers sequentially) is held in the unlatched position.

### SUMMARY OF THE INVENTION

Advantageous embodiments of the invention are named in the following and in the dependent claims.

In accordance with a particularly simple embodiment, the named toothed zone of the at least one disk tumbler and the associated counter-toothed zone of the cylinder lock have at least one recess or at least one raised portion which can be introduced into the recess. The explained toothed engagement can hereby already be realized to be able to block the respective disk tumbler in the latched position since anyway no particularly high forces can be transmitted by means of the picking tools usually used.

The mutual toothed engagement is furthermore particularly effective when the toothed zone of the at least one disk tumbler and the associated counter-toothed zone of the cylinder lock cooperate in a direction which extends substantially perpendicular to the direction of bias. In other words, a shape matched connection can hereby be realized which particularly reliably prevents an unauthorized displacement of the disk tumbler into the unlatched position.

In accordance with a further embodiment, the toothed zone of the at least one disk tumbler and the counter-toothed zone of the cylinder lock cooperate within the cylinder core, i.e. radially within the ring gap between the cylinder housing and the cylinder core with respect to the axis of rotation. A simpler and more exact formation of the counter-toothed zone is hereby possible since this does not, for example, have to be worked into the named cut-out of the cylinder housing (for the engagement section of the disk tumbler).

To ensure a proper function of the cylinder lock on an authorized actuation by means of the associated key despite the usual tolerances, it is preferred if the named toothed zone of the at least one disk tumbler and the associated counter-toothed zone of the cylinder lock cooperate with one another such that the explained mutual engagement can be cancelled in that a torque is exerted onto the cylinder core against the rotary opening direction. To be able to cancel an unintended blocking of the respective disk tumbler in the latched position due to the explained toothed engagement, it is therefore only necessary to rotate the cylinder core briefly against the rotary opening direction by means of the associated key.

In accordance with a further advantageous embodiment, the at least one disk tumbler has a further engagement section in addition to the named engagement section, said further engagement section being disposed opposite the named engagement section with respect to the respective direction of bias. The disk tumbler in this case blocks the cylinder core against a rotary movement relative to the cylinder housing even when the disk tumbler is moved opposite to the respective direction of bias in the direction of a further latched position in which the further engagement section engages into an associated further cut-out in the cylinder housing. The disk tumbler in this embodiment also has yet a further toothed zone which can be brought into engagement with the named counter-toothed zone of the cylinder lock such that the disk tumbler is blocked against a movement along the respective direction of bias when the disk tumbler is in the further latched position and a torque is exerted onto the cylinder core in the rotary opening direction. In other words, the further engagement section of the disk tumbler likewise serves to block the cylinder core against a rotary movement relative to the cylinder housing if it should prove possible to move the disk tumbler opposite to the direction of bias despite the explained toothed engagement (between the named toothed zone and the counter-toothed zone) and if the disk tumbler in so doing is moved beyond the unlatched position into the further latched position. In such a case, the toothed engagement between the named further toothed zone and the associated counter-toothed zone results in a rotation of the cylinder core not being possible. This embodiment therefore contributes to a further increase of the security against manipulation.

In accordance with a preferred embodiment, the named counter-toothed zone is provided at least one blocking element of the cylinder lock which is formed separately from the cylinder core and from the cylinder housing. The manufacture of the cylinder lock is hereby simplified since the counter-toothed zone can, for example, be made as an external toothed arrangement of the named blocking element and does not, for instance, have to be worked into a groove of the cylinder housing or the like.

On the presence of such a separate blocking element, it is furthermore preferred if it is movably supported at the cylinder core. The movability of a separate blocking element can be used to make the bringing into engagement of the named toothed zone and associated counter-toothed zone even more reliable and to provide additional protection against rotation for the cylinder core.

The named blocking element can in particular be pivotably supported at the named cylinder core, with the pivot axis preferably extending parallel to the axis of rotation of the cylinder core.

So that the counter-toothed zone of the named blocking element can also be reliably brought out of engagement with the associated toothed zone of the respective disk tumbler again, it is furthermore preferred if the named blocking element is biased in the direction of the cylinder housing, that is in a direction away from the respective toothed zone or from the respective disk tumbler.

Provided the named blocking element is movable, it is furthermore preferred if the blocking element is supported at the cylinder housing while the toothed zone of the respective disk tumbler cooperates in the explained manner with the counter-toothed zone to block the disk tumbler in the latched position. It is ensured by the support of the blocking element at the cylinder housing that, in the case of an application of a torque onto the cylinder core in the rotary opening direction, a mutual engagement is reliably established between the named toothed zone and the associated counter-toothed zone and that the blocking element in this respect does not, for instance, follow the rotary movement of the cylinder core. In other words, it is ensured that the blocking element of the associated disk tumbler does not “run away”.

It is of particular advantage if the named blocking element, while it is supported at the cylinder housing, blocks the cylinder core against a rotary movement relative to the cylinder housing. In other words, the named blocking element can (in addition to the cooperation of the engagement section of the respective disk tumbler with the associated cut-out in the cylinder housing) form a security against rotation for the cylinder core. The disk tumblers can thus have comparatively small dimensions. Particularly compact constructional shapes of the cylinder lock hereby result with a correspondingly small thickness of the disk tumblers in particular in the axial direction (again with respect to the axis of rotation of the cylinder core).

In accordance with a further advantageous embodiment, the named disk tumbler has, adjacent to the named toothed zone, a release cut-out into which the respective blocking element can engage when the disk tumbler is in the latched position due to the proper use of the associated key, with the blocking of the cylinder core by the blocking element explained above being cancelled when the blocking element engages into the release cut-out of the disk tumbler. The named release cut-out thus enables a movement of the blocking element to cancel the explained security against rotation between the cylinder core and the cylinder housing, with the corresponding movement of the blocking element only being possible, however, when the respective disk tumbler is in the unlatched position.

In accordance with a further embodiment, a respective blocking element is associated with a plurality of disk tumblers, in particular with all the disk tumblers of the cylinder lock. A particularly high security against manipulation hereby results.

A common blocking element can in particular be associated with the plurality of disk tumblers. A plurality of separate blocking elements is thus not necessary, with an advantageously simple structure of the cylinder lock resulting from this.

### BRIEF DESCRIPTION OF THE DRAWINGS

The invention will be described in the following only by way of example with reference to the drawings.

FIG. 1 shows a disk tumbler lock in an exploded view;

FIGS. 2a and 2b show the disk tumbler lock in the latched state in a cross-sectional view or in a perspective view (without cylinder housing);

FIGS. 3a and 3b show the disk tumbler in the unlatched state in a cross-sectional view (with the cylinder core being rotated by 90°) or in a perspective view (without cylinder housing).

### DETAILED DESCRIPTION OF THE PREFERRED EMBODIMENTS

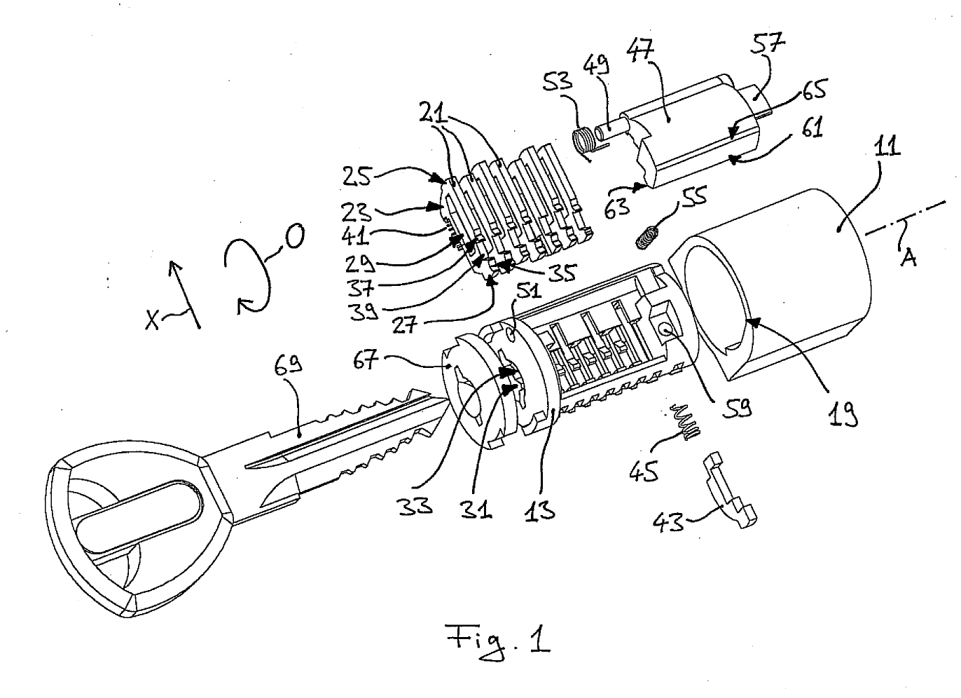

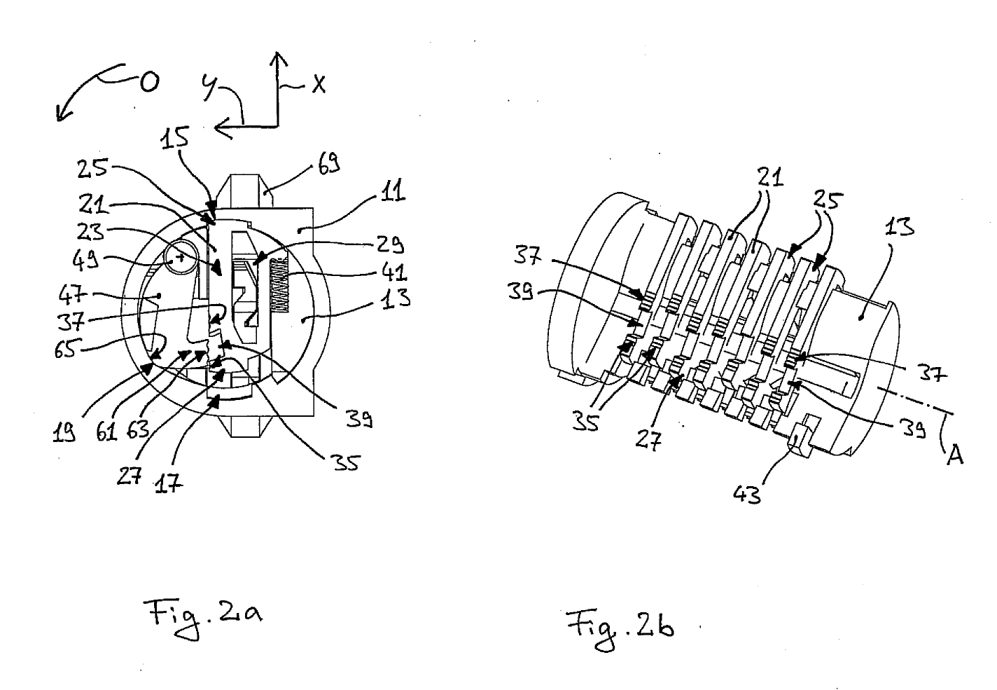

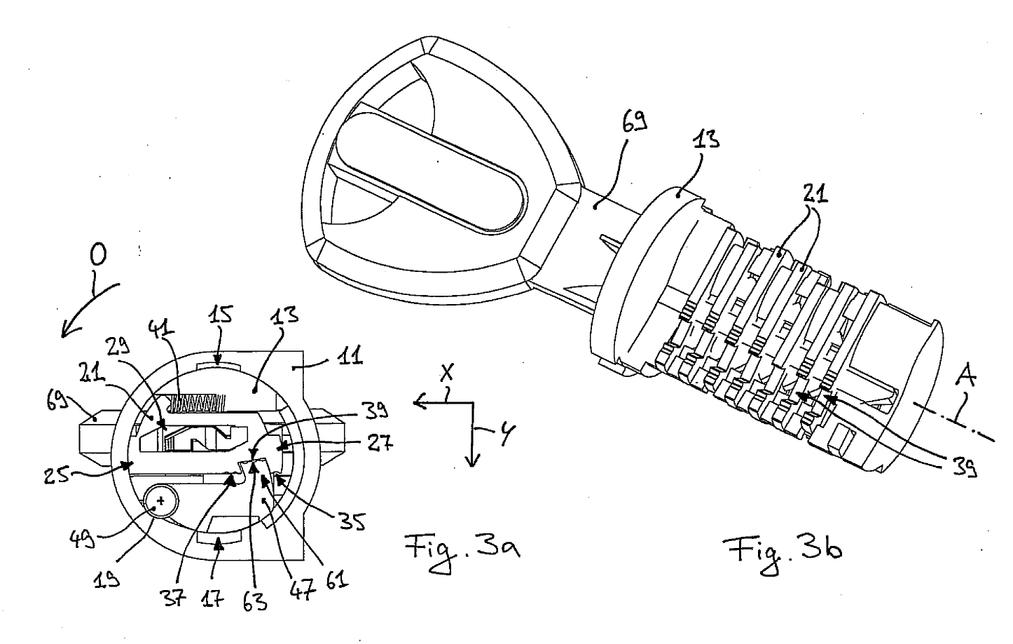

The shown disk tumbler cylinder lock will first be described mainly with respect to FIG. 1. The lock has a cylinder housing 11 and a cylinder core 13 rotatable therein. The cylinder housing 11 has a cut-out 15 and a further cut-out 17 (FIGS. 2a and 3a) which extend in groove shape at the inner jacket surface of the cylinder housing 11 parallel to the axis of rotation A of the cylinder core 13, with the two cut-outs 15, 17 being disposed diametrically opposite one another. The cylinder housing 11 furthermore has a blocking cut-out 19 at its inner jacket surface which likewise extends parallel to the axis of rotation A. The cut-outs 15, 17 and the blocking cut-out 19 form deviations from an essentially circular cross-section of the inner jacket surface of the cylinder housing 11.

A plurality of tumbler disks 21 are held movably in translatory manner in the cylinder core 13. Each disk tumbler 21 has a core section 23, an engagement section 25 and a further engagement section 27 disposed diametrically opposite thereto with respect to the axis of rotation A. The respective core section 23 surrounds a key opening 29 of the respective disk tumbler, with the key openings 29 of the disk tumblers 21 and an introduction opening 31 of the cylinder core 13 together forming a keyway 33. A toothed zone 35 and (adjacent hereto in the direction of bias X) a further toothed zone 37 are formed at each disk tumbler 21. A release cut-out 39 is provided between the toothed zone 35 and the further toothed zone 37 of each disk tumbler 21. The release cut-out 39 is thus likewise arranged adjacent to the respective toothed zone 35 in the direction of bias X. Furthermore, a biasing spring 41 is associated with each disk tumbler 21 by means of which the disk tumbler 21 is biased along a direction of bias X into a latched position to be explained in the following.

The shown disk tumbler cylinder lock furthermore includes a tumbler 43 as a security against rotation which is likewise held movably in the cylinder core 13 and with which a biasing spring 45 is associated.

The disk tumbler cylinder lock furthermore has a blocking element 47 which is pivotably journaled at the cylinder core 13 by means of a link pin 49 which engages into a linking opening 51 of the cylinder core 13. The link pin 49 passes through a torsion spring 53 which cooperates with the blocking element 47 and the cylinder core 13 to bias the blocking element 47 into a direction of bias Y away from the respective toothed zone 35 of the disk tumblers 21, as will be explained in the following (FIGS. 2a and 3a). This bias is also supported by a compression spring 55 which engages between a support section 57 of the blocking element 47 and a spring mount 59 of the cylinder core 13. The blocking element 47 furthermore has a web section 61 which extends parallel to the axis of rotation A of the cylinder core 13. The web section 61 has a counter-toothed zone 63 at the side facing the disk tumblers 21. The blocking element 47 furthermore has at its outer side remote from the disk tumblers 21 a support section 65 which likewise extends parallel to the axis of rotation A.

The shown disk tumbler lock furthermore includes a drill protection plate 67 and an associated key 69.

The general operation of the shown tumbler disk cylinder lock will be explained in the following mainly with reference to FIGS. 2a and 3a. FIG. 2a shows the lock before the complete introduction of the associated key 69. Due to the bias by means of the respective biasing spring 41, the disk tumblers 21 are in a latched position in which the respective engagement section 25 engages into the associated cut-out 15 of the cylinder housing 11. The cylinder core 13 is hereby blocked against a rotary movement relative to the cylinder housing 11. If, in contrast, the associated key 69 is introduced completely into the keyway 33, the disk tumblers 21 are brought opposite to the direction of bias X into a respective unlatched position in which the engagement sections 25 are withdrawn from the cut-out 15 of the cylinder housing 11 at the level of the ring gap which is formed between the cylinder housing 11 and the cylinder core 13. The cylinder core 13 can now be rotated in the direction of opening O by means of the key 69. FIG. 3a shows the result of such a rotation through 90°. The rotational security tumbler 43 (FIG. 1) prevents a rotary actuation of the cylinder core 13 as long as the associated key 69 is not completely introduced into the keyway 33.

It must be noted that, for the different disk tumblers 21, the directions of bias X can also be directed opposite to one another, in particular on the use of a reversible key 69. In this case, the latched position of one of the disk tumblers 21 is therefore disposed diametrically opposite the latched position of another of the disk tumblers 21.

A special feature of the shown disk tumbler cylinder lock is the respective toothed zone 35 of the disk tumblers 21 which cooperates with the counter-toothed zone 63 at the web section 61 of the pivotable blocking element 47. Provided that a torque is exerted onto the cylinder core 13 in the direction of opening O, as long as the respective disk tumbler 21 is still in the latched position in accordance with FIG. 2a, the respective toothed zone 35 of the disk tumblers 21 enters into shape matched engagement with the named counter-toothed zone 63. The blocking element 47 biased in the direction of bias Y is namely supported at the inner jacket surface of the cylinder housing 11, with the support section 65 of the blocking element 47 engaging into the blocking cut-out 19 of the cylinder housing 11 so that the blocking element 47 cannot escape backward despite the named torque loading onto the cylinder core 13. Due to the shape matched engagement thus brought about between the toothed zone 35 and the counter-toothed zone 63, the respective disk tumbler 21 is blocked against a movement opposite to the direction of bias X, that is from the latched position shown in FIG. 2a in the direction of the unlatched position. The lock is hereby effectively protected against unauthorized opening by successive “setting” of the disk tumblers 21 while applying a torque, with a displacement of the respective disk tumblers 21 from the latched position into the unlatched position not being permitted at all.

The active direction of the named shape matched engagement between the respective toothed zone 35 and the counter-toothed zone 63 in this respect extends substantially perpendicular to the direction of bias X of the disk tumblers 21, i.e. substantially parallel to the direction of bias Y of the blocking element 47. Due to the bias of the blocking element 47 in the direction Y, an unintentional mutual engagement of the toothed zone 35 of the disk tumbler 21 and of the counter-toothed zone 63 of the blocking element 47 is prevented.

It is achieved by the engagement of the support section 65 of the blocking element 47 into the blocking cut-out 19 of the cylinder housing 11 that the blocking element 47 blocks the cylinder core 13 (in addition to the engagement sections 25 of the disk tumblers 21) against a rotary movement relative to the cylinder housing 11 as long as the disk tumblers 21 are in the latched position in accordance with FIG. 2a. However, as soon as all disk tumblers 21 have been brought into the respective unlatched position by introduction of the associated key 69 into the keyway 33, the web section 61 of the blocking element 47 can pivot into the respective release cut-out 39 of the disk tumblers 21 by rotating the cylinder core 13 in the rotary opening direction O so that the explained additional blocking effect of the blocking element 47 is cancelled. The inner jacket surface of the cylinder housing 11 in this respect acts as a slotted link guide for the pivot movement of the blocking element 47. FIG. 3b shows that the release cut-outs 39 of the disk tumblers 21 in this state form a throughgoing groove for the reception of the web section 61 of the blocking element 47.

It can also still be seen from FIG. 2a that the further cut-out 17 of the cylinder housing 11 enables a cooperation with the respective further engagement section 27 of the disk tumblers 21 to block the cylinder core 13 against a rotary movement relative to the cylinder housing 11 if the respective disk tumbler 21 is moved out of the latched position in accordance with FIG. 2a beyond the explained latched position into a further latched position. In this case, a shape matched engagement is effected between the further toothed zone 37 of the respective disk tumbler 21 and the counter-toothed zone 63 of the blocking element 47 to prevent a movement back of the disk tumbler 21 as long as a torque is exerted onto the cylinder core 13 in the rotary opening direction O.

1. A cylinder lock of the type of a disk tumbler cylinder, having a cylinder housing and a cylinder core rotatable therein, wherein a plurality of disk tumblers are provided in the cylinder core which have at least one respective engagement section, with the disk tumblers being movable between an unlatched position and a latched position and being biased along a respective direction of bias into the latched position, with the respective engagement section engaging in the latched position into an associated cut-out in the cylinder housing to block the cylinder core against a rotary movement relative to the cylinder housing, and with the cylinder core being rotatable relative to the cylinder housing in a rotary opening direction when the disk tumblers are in the unlatched position,
wherein at least one of the disk tumblers has a toothed zone which can be brought into engagement with a counter-toothed zone of the cylinder lock such that the disk tumbler is blocked against a movement opposite to the respective direction of bias when disk tumbler is in the latched position and a torque is exerted onto the cylinder core in the rotary opening direction.

2. A cylinder lock in accordance with claim 1, wherein the toothed zone of the at least one disk tumbler and the counter-toothed zone of the cylinder lock have at least one recess and at least one elevated portion which can be introduced into the recess.

3. A cylinder lock in accordance with claim 1, wherein the toothed zone of the at least one disk tumbler and the counter-toothed zone of the cylinder lock cooperate in a direction which extends substantially perpendicular to the respective direction of bias.

4. A cylinder lock in accordance with claim 1, wherein the toothed zone of the at least one disk tumbler and the counter-toothed zone of the cylinder lock cooperate within the cylinder core.

5. A cylinder lock in accordance with claim 1, wherein the toothed zone of the at least one disk tumbler and the counter-toothed zone of the cylinder lock cooperate such that the mutual engagement can be cancelled in that a torque is exerted onto the cylinder core against the rotary opening direction.

6. A cylinder lock in accordance with claim 1, wherein the at least one disk tumbler has a further engagement section which is disposed opposite the named engagement section with respect to the respective direction of bias, wherein the disk tumbler blocks the cylinder core against a rotary movement relative to the cylinder housing when the disk tumbler is moved opposite to the respective direction of bias in the direction of a further latched position in which the further engagement section engages into an associated further cut-out in the cylinder housing, wherein the disk tumbler has a further toothed zone which can be brought into engagement with the named counter-toothed zone of the cylinder lock such that the disk tumbler is blocked against a movement along the respective direction of bias when the disk tumbler is in the further latched position and a torque is exerted onto the cylinder core in the rotary opening direction.

7. A cylinder lock in accordance with claim 1, wherein the counter-toothed zone is provided at least one blocking element of the cylinder lock which is made separately from the cylinder core and from the cylinder housing.

8. A cylinder lock in accordance with claim 7, wherein the at least one blocking element is movably supported at the cylinder core.

9. A cylinder lock in accordance with claim 7, wherein the at least one blocking element is pivotably supported at the cylinder core.

10. A cylinder lock in accordance with claim 7, wherein the at least one blocking element is biased in the direction of the cylinder housing.

11. A cylinder lock in accordance with claim 7, wherein the at least one blocking element is supported at the cylinder housing while the toothed zone of the at least one disk tumbler cooperates with the counter-toothed zone of the at least one blocking element.

12. A cylinder lock in accordance with claim 11, wherein the at least one blocking element blocks, while it is supported at the cylinder housing, the cylinder core against a rotary movement relative to the cylinder housing.

13. A cylinder housing in accordance with claim 12, wherein the at least one disk tumbler has, adjacent to the toothed zone, a release cut-out into which the at least one blocking element can be introduced when the disk tumbler is in the unlatched position, with the blocking of the cylinder core by the blocking element being cancelled when the blocking element engages into the release cut-out of the disk tumbler.

14. A cylinder lock in accordance with claim 11, wherein the at least one blocking element engages, while it is supported at the cylinder housing, into a blocking cut-out in the cylinder housing.

15. A cylinder lock in accordance with claim 7, wherein a blocking element is associated with a plurality of disk tumblers, in particular with all of the disk tumblers.

16. A cylinder lock in accordance with claim 15, wherein a common blocking element is associated with the plurality of disk tumblers.

17. A cylinder lock in accordance with claim 13 and claim 16, wherein the blocking element has a web section which engages into the respective release cut-out of the disk tumblers when the plurality of disk tumblers are in the unlatched position.

18. A cylinder lock of the type of a disk tumbler cylinder, having a cylinder housing and a cylinder core rotatable therein, wherein a plurality of disk tumblers are provided in the cylinder core which have at least one respective engagement section, with the disk tumblers being movable between an unlatched position and a latched position and being biased along a respective direction of bias into the latched position, with the respective engagement section engaging in the latched position into an associated cut-out in the cylinder housing to block the cylinder core against a rotary movement relative to the cylinder housing, and with the cylinder core being rotatable relative to the cylinder housing in a rotary opening direction when the disk tumblers are in the unlatched position,
wherein at least one of the disk tumblers has a toothed zone which can be brought into engagement with a counter-toothed zone of the cylinder lock such that the disk tumbler is blocked against a movement opposite to the respective direction of bias when disk tumbler is in the latched position and a torque is exerted onto the cylinder core in the rotary opening direction,
wherein the toothed zone of the at least one disk tumbler and the counter-toothed zone of the cylinder lock cooperate within the cylinder core,
wherein the counter-toothed zone is provided at least one blocking element of the cylinder lock which is made separately from the cylinder core and from the cylinder housing,
wherein the at least one blocking element is movably supported at the cylinder core, and
wherein the at least one blocking element is supported at the cylinder housing while the toothed zone of the at least one disk tumbler cooperates with the counter-toothed zone of the at least one blocking element.

19. A cylinder lock in accordance with claim 18, wherein the at least one blocking element, while it is supported at the cylinder housing, engages into a blocking cut-out in the cylinder housing and thereby blocks the cylinder core against a rotary movement relative to the cylinder housing.
